(19) United States
(12) Patent Application Publication
(10) Pub. No.: US 2023/0013573 A1
(43) Pub. Date: Jan. 19, 2023

(54) PORTABLE FOOD PREPARATION APPARATUS

(71) Applicant: Yakima Products, Inc., Lake Oswego, OR (US)

(72) Inventors: Scott A. McFadden, Portland, OR (US); Jason Attfield Sagen, Portland, OR (US); Gian-Marco D'Angelo, Portland, OR (US); Ashley Hoch, Portland, OR (US); Brandon Michael Willems, Portland, OR (US)

(73) Assignee: Yakima Products, Inc., Lake Oswego, OR (US)

(21) Appl. No.: 17/866,207

(22) Filed: Jul. 15, 2022

Related U.S. Application Data
(60) Provisional application No. 63/222,373, filed on Jul. 15, 2021.

(51) Int. Cl. A45F 3/46; A45C 9/00; A45C 13/02; A47J 47/00

(52) U.S. Cl. CPC A45F 3/46; A45C 9/00; A45C 13/02; A47J 47/00

(57) ABSTRACT

A portable kitchen assembly is disclosed, including a rectangular container and stowable legs for supporting the container at a convenient height for standing preparation of food. The rectangular container has a top wall, bottom wall, back wall, front wall, and first and second side walls. The front wall is configured to open to a kitchen counter position, and the stowable legs are attachable to an external side of the bottom wall.

### CROSS-REFERENCES

This application claims the benefit under 35 U.S.C. § 119(e) of the priority of U.S. Provisional Patent Application Ser. No. 63/222,373, filed Jul. 15, 2021, the entirety of which is hereby incorporated by reference for all purposes.

### BACKGROUND

The growing popularity of outdoor recreational activities has increased demand for different ways to carry a variety of recreational equipment in and on vehicles. A type of camping referred to as ‘connected camping’ or ‘car camping’ is one such activity, in which recreators remain close to their vehicle and in some cases utilize the vehicle for shelter, structure, and/or storage. Equipment for such camping has proliferated, including rooftop tents, roof rack mounted awnings, and vehicle-powered charging stations. An aspect of camping which may benefit from practical, easy to use, well-designed equipment is food preparation.

### SUMMARY

The present disclosure provides systems, apparatus, and methods relating to food preparation. In some examples, a portable kitchen assembly may include a rectangular container and stowable legs for supporting the container at a convenient height for standing preparation of food. The rectangular container may have a top wall, bottom wall, back wall, front wall, and first and second side walls. The front wall may be configured to open to a kitchen counter position, and the stowable legs may be attachable to an external side of the bottom wall.

In some examples, a portable food preparation apparatus may include a main body having a top wall, a bottom wall, and three side walls connecting the top and bottom walls. The main body may further include a door hinged to an edge of the bottom wall and securable to the top wall, and an interior compartment defined by the top, bottom, and side walls. The door may have a transport position perpendicular to the top and bottom walls, and a food preparation position in which the door is parallel the top and bottom walls. The interior compartment may be configured for storage of food preparation equipment and/or food items when the door is in the transport position. An inner side of the door may be configured for use as a work surface when the door is in the food preparation position.

In some examples, a method of outdoor food preparation may include packing food preparation equipment into a portable food preparation apparatus and closing a door of the apparatus. The method may further include transporting the apparatus to an outdoor location with a vehicle, opening the door of the apparatus, and mounting at least one accessory to the apparatus. The method may further include preparing food, using the packed equipment and using the opened door as a work surface.

Features, functions, and advantages may be achieved independently in various examples of the present disclosure, or may be combined in yet other examples, further details of which can be seen with reference to the following description and drawings.

### BRIEF DESCRIPTION OF THE DRAWINGS

FIG. 1 is an isometric view of an illustrative portable kitchen in accordance with aspects of the present disclosure, with a door in a transport position.

FIG. 2 is an isometric view of the portable kitchen of FIG. 1, with the door in a food preparation position and a lantern pole and organizer accessory installed.

FIG. 3 is an isometric view of the portable kitchen of FIG. 1, with the door in a food preparation position, on a table.

FIG. 4 is an isometric view of the portable kitchen of FIG. 1, from below.

FIG. 5 is an isometric detail view of an inner side of a door latch of the portable kitchen of FIG. 1.

FIG. 6 is an exploded view of the door latch of FIG. 5.

FIG. 7 is an isometric view of the portable kitchen of FIG. 5, with two side counter accessories and a set of legs installed.

FIG. 8 is an isometric view of the set of legs of FIG. 7, disassembled.

FIG. 9 is an isometric view of the set of legs of FIG. 7, assembled.

FIG. 10 is a detail view of a side wall of the portable kitchen of FIG. 1, with side rungs installed.

FIG. 11 is a cross-sectional detail view through the side wall of FIG. 10, with a side table accessory installed.

### DETAILED DESCRIPTION

Various aspects and examples of a portable food preparation apparatus, as well as related accessories and methods, are described below and illustrated in the associated drawings. Unless otherwise specified, a portable food preparation apparatus in accordance with the present teachings, and/or its various components may, but are not required to, contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed examples. The following description of various examples is merely illustrative in nature and is in no way intended to limit the disclosure, its application, or uses. Additionally, the advantages provided by the examples described below are illustrative in nature and not all examples provide the same advantages or the same degree of advantages.

This Detailed Description includes the following sections, which follow immediately below: (1) Definitions; (2) Overview; (3) Examples, Components, and Alternatives; (4) Illustrative Combinations and Additional Examples; and (5) Conclusion.

### Definitions

The following definitions apply herein, unless otherwise indicated. Additionally, as used herein, like numerals refer to like parts.

“Substantially” means to be predominantly conforming to the particular dimension, range, shape, concept, or other aspect modified by the term, such that a feature or component need not conform exactly, so long as it is suitable for its intended purpose or function. For example, a “substantially cylindrical” object means that the object resembles a cylinder, but may have one or more deviations from a true cylinder.

“Approximately” as used herein when referring to a measurable value such as a parameter, an amount, a temporal duration, and the like, is meant to encompass variations of +/−10% or less, preferably +/−5% or less, more preferably +/−1% or less, and still more preferably +/−0.1% or less of the specified value, insofar as such variations are appropriate to perform in the disclosure. It is to be understood that the value to which the modifier “approximately” refers is itself also specifically, and preferably, disclosed.

### OVERVIEW

In general, a portable food preparation apparatus may include an enclosure, box, case, tote, or main unit which organizes equipment for storage and transport, and also opens up to become a kitchen workspace. A user may pack the unit with cooking and/or food preparation equipment and/or ingredients at home, transport the unit to a camp, campsite, or other outdoor location, and then utilize the unit as a kitchen workspace.

The size and form of the unit may be configured for transport inside a vehicle internal cargo area and/or on an external vehicle rack system such as a hitch rack, roof rack, truck rack, or trailer. The unit may be used as a kitchen workspace while mounted on such a vehicle rack system, out of the back of a vehicle/tailgate, on another freestanding table, on a trailer, or supported by attachable freestanding legs.

The portable food preparation apparatus may be described as deploying from a transport or stowed mode to a food preparation mode. The main unit may be deployed by opening a front door, which then forms a work surface. Alternatively, a top wall of the unit can be used as a work surface, depending on the height of the surface or vehicle supporting the unit. The apparatus may be configured to supply multiple work surfaces for flexibility, for many users in many different environments.

Work surface area may also be expanded by adding table extension accessories to the main unit of the food preparation apparatus. Such accessories may also be described as side tables, side counters, work surface extensions, or extensions. A work surface extension accessory may be supported at one side by the main unit. For example, such an accessory may clip to a side rung of the main unit, may slot into apertures in the main unit, or may otherwise fasten to a side wall of the main unit. The accessory may be configured for manual connection to and release from the main unit, for ease of use. For instance, the accessory may connect using snap-fit hooks or pull-to-release latches.

A work surface extension accessory may include a planar portion such as a piece of wood, sheet of metal, or expanse of rigid plastic. The accessory may further include a leg, and attachment pieces for connection to the main unit. The leg may be removeable by the user to allow storage of the planar portion and/or the leg inside of the main unit during transport. The leg may be adjustable in length to permit leveling on variable surfaces as well as for placing the main unit and/or work surface extension accessory at many different working heights.

The food preparation apparatus may be configured for use at various heights. For example, the apparatus may be used on varying vehicle racks, vehicle interior surfaces, tables, or tail gates with different heights. To accommodate such height variation, the table extension accessories may be configured to mount at multiple heights or positions on the main unit, as required by users. For example, the main unit may include multiple side rungs, each appropriate for mounting.

The food preparation apparatus may be weather resistant and designed for mounting on the exterior of a vehicle. For example, the main unit may have a HDPE rotomolded body with a tough, IP54 rated enclosure. Features may be included in the molded shape to keep cost and weight down, limit part count, and avoid potential for rust.

The main unit of the food preparation apparatus may be configured for attachment to a vehicle rack or other load support system. For example, the main unit may include cleats designed to engage the clamps of a multi-use adaptable hitch-mounted load support system such as the example described in U.S. patent application Ser. No. 17/376,038 which is hereby incorporated by reference.

Other accessories may be included in the food preparation apparatus. Each accessory may be mountable to the main unit of the apparatus and/or another accessory. For example, the apparatus may include a stove or griddle accessory configured to mount in the same manner as a table extension accessory, a backboard organizer configured to mount vertically from the main unit and/or a table extension accessory, a collapsible sink configured to insert into a table extension accessory, water source for the sink, hand washing or sanitizing station, and/or a lantern suspended from a pole configured to mount into the main unit.

Supports, brackets, hooks, loops, or other features may be included on the main unit and/or accessories for support or attachment of related equipment. For example, a table extension accessory may include a hose nozzle hook, a propane tank bracket, and/or a towel bar.

Accessories of the food preparation apparatus may be configured for assembly in a plurality of possible combinations and/or arrangements. Multiple threaded inserts may be molded into the main unit to mount parts and accessory components. A user may select accessories and/or mounting positions as desired for a particular location, use, or food preparation task.

### Examples, Components, and Alternatives

The following sections describe selected aspects of exemplary portable food preparation apparatus as well as related systems and/or methods. The examples in these sections are intended for illustration and should not be interpreted as limiting the entire scope of the present disclosure. Each section may include one or more distinct examples, and/or contextual or related information, function, and/or structure.

### A. Illustrative Portable Kitchen

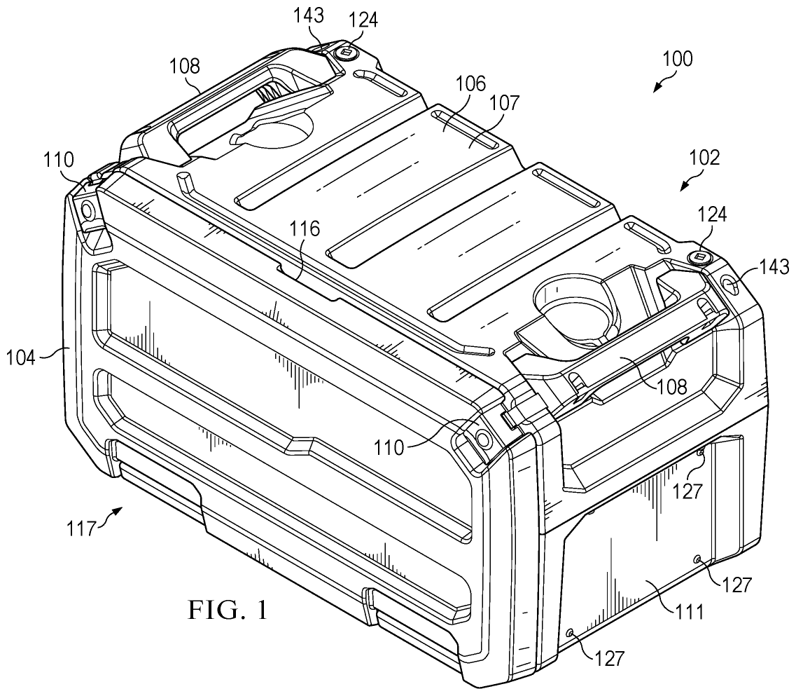

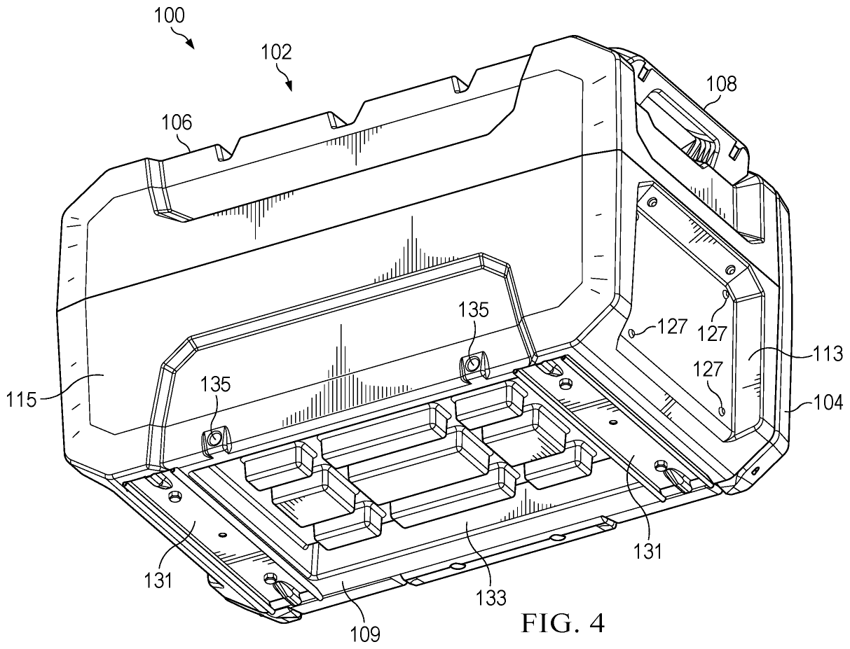

As shown in FIGS. 1-11, this section describes an illustrative portable kitchen assembly 100. Kitchen 100 is an example of a portable food preparation apparatus, as described above. The kitchen includes a substantially rectangular main unit or box 102, as depicted in FIGS. 1 and 4, with a door 104 and an enclosure 106.

Enclosure 106 includes a top wall 107, a bottom wall 109, a first side wall 111, a second side wall 113, and a rear wall 115. Rear wall 115 may also be referred to as a third side wall. First side wall 111, second side wall 113, and rear wall 115 may be described as connecting top wall 107 to bottom wall 109. Each wall of enclosure 106 may be described as having an external, exterior, or outer side, and an internal, interior, or inner side.

A pair of handles 108 are fixed to top wall 107, for lifting box 102. One handle of the pair is disposed proximate each of side walls 111, 113. Top and side walls 107, 111, 113 are shaped to form a recess surrounding each handle 108, providing space for a user's hand between the handle and box 102. A single user may lift box 102 by both handles, or two users may cooperatively lift the box by each using one of the handles. Cooperative lifting using the two handles may allow easy lifting even when box 102 is packed with heavy food and/or equipment.

In the present example, enclosure 106 is single wall high density polyethylene (HDPE) rotomolded and door 104 is double wall HDPE rotomolded. All exterior surfaces of box 102 are textured, and the door includes an ethylene propylene diene monomer (EDPM) seal. Lift handles 108 are injection molded nylon. In some examples, enclosure 106 and door 104 may comprise other plastics and may be otherwise formed. In some examples, the enclosure and door may include other strong and lightweight materials such as aluminum. In some examples, box 102 may include insulating materials.

The door and walls of box 102 include deeply recessed geometry for structural strength. Door 104 and walls 107, 109, 111, 113, 115 each include a plurality of recesses. Deep channel ‘kiss-offs’ improve stiffness and torsional stability, and are wide with angled surfaces to allow easy cleaning. Incorporated into top wall 107 are molded-in cup holders.

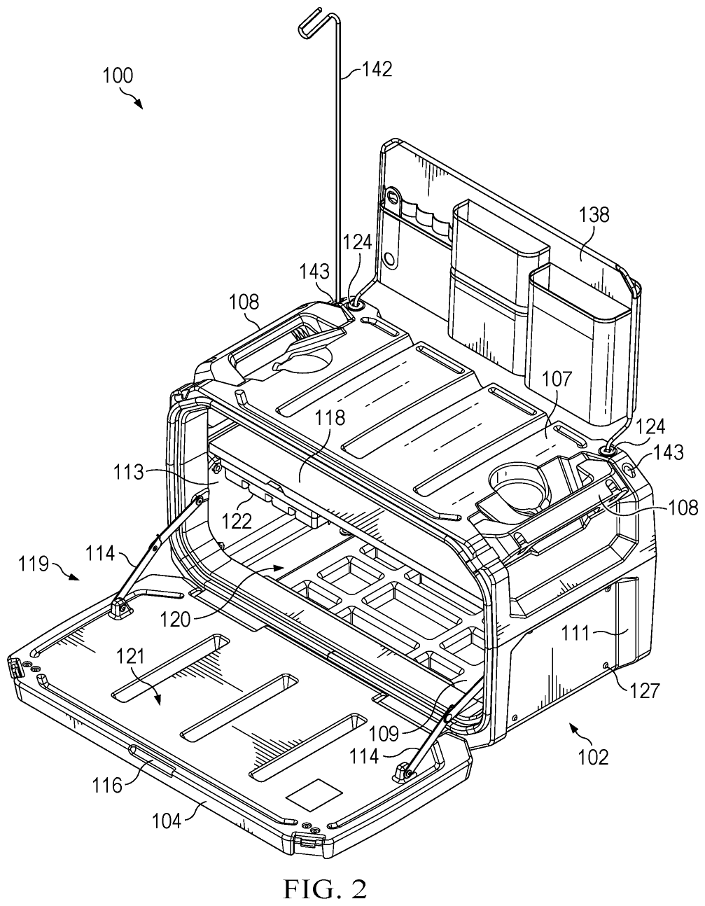

Box 102 has a transportation mode 117, shown in FIGS. 1 and 4 and a food preparation mode 119 shown in FIGS. 2, 3, and 7. The box may also be described as having a storage position and a use position. In transportation mode 117, door 104 is closed. When closed, the door is vertical, perpendicular to the top and bottom walls and parallel to the back wall.

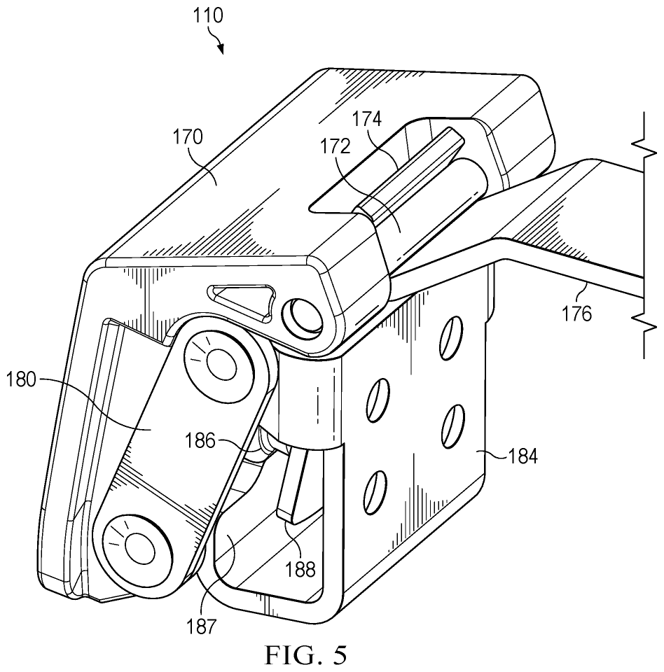

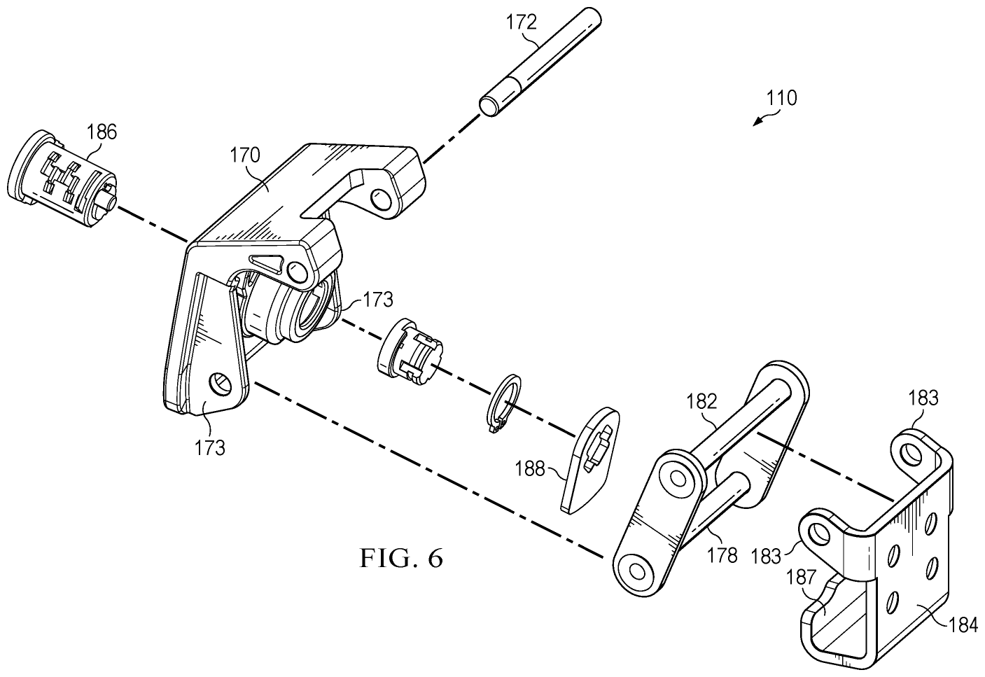

When closed, door 104 is secured to enclosure 106 by two locking over-center latches 110. Each latch is positioned at an upper corner of door 104, to engage a hook at a forward edge of upper corners of box 102, where top wall 107 meets first side wall 111 and second side wall 113. Latches 110 are described in greater detail with reference to FIGS. 5 and 6, below. To open door 104, a user may unlock and release latches 110, then pull on finger-pull recess 116 at the top of door 104.

In FIG. 2, box 102 is deployed in food preparation mode 119, with attached accessories. In the food preparation mode, door 104 is open. When open, door 104 is horizontal, parallel to the top and bottom walls of enclosure 106, and may be described as in a flat or kitchen counter position. The door opens out away from enclosure 106 through a range of approximately 90 degrees, and is supported in the open position by a pair of folding steel door supports 114. The door may additionally or alternatively include any effective supports to maintain the horizontal position. Door 104 is hinged to a front edge 123 of the bottom wall of enclosure 106. Metal components of the hinges are enclosed by the rotomolded HDPE of door and bottom wall, to avoid environmental exposure.

In the present example, enclosure 106 includes a front lip on the top, bottom, and side walls. The front lip is shaped to contact an inner surface 121 of door 104. A flange formed on the lip may include or retain a gasket or seal to form a seal between door 104 and enclosure 106 when the door is closed. Such a seal may help to maintain a desired temperature inside box 102 during transport, avoid leakage from spilled ingredients inside the box, and/or weatherproof the box and prevent intrusion of dust, dirt, or water from the environment into the box.

Inner surface 121 of door 104 is configured for use as a food preparation work surface. In some examples, kitchen 100 may include a separate cover or cutting board, shaped to cover inner surface 121. In some examples, structural recesses or other features of door 104 may be covered by a planar inner layer forming inner surface 121.

Enclosure 106 defines an interior compartment or storage space 120. Box 102 further includes an inner shelf 118, which may be described as dividing interior space 120 of the enclosure into upper and lower compartments. A utensil drawer 122 is mounted in slides on an underside of shelf 118, in the lower compartment. The drawer may be removed to increase storage volume in the lower compartment. In some examples, a flat floor may be installed at the bottom of the lower compartment, covering any channels or recesses on the inner side of bottom wall 109.

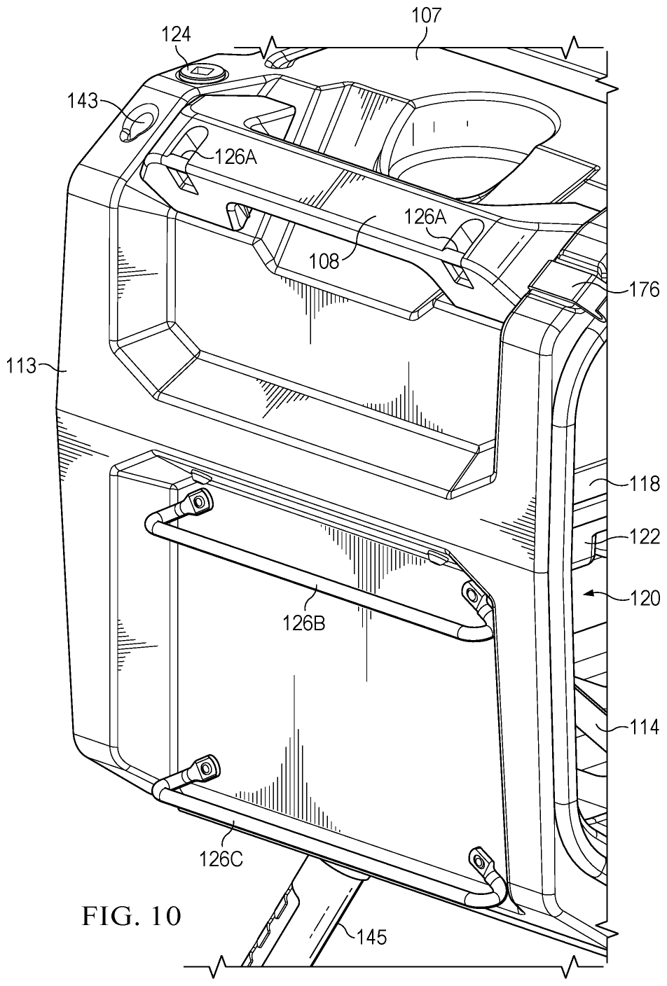

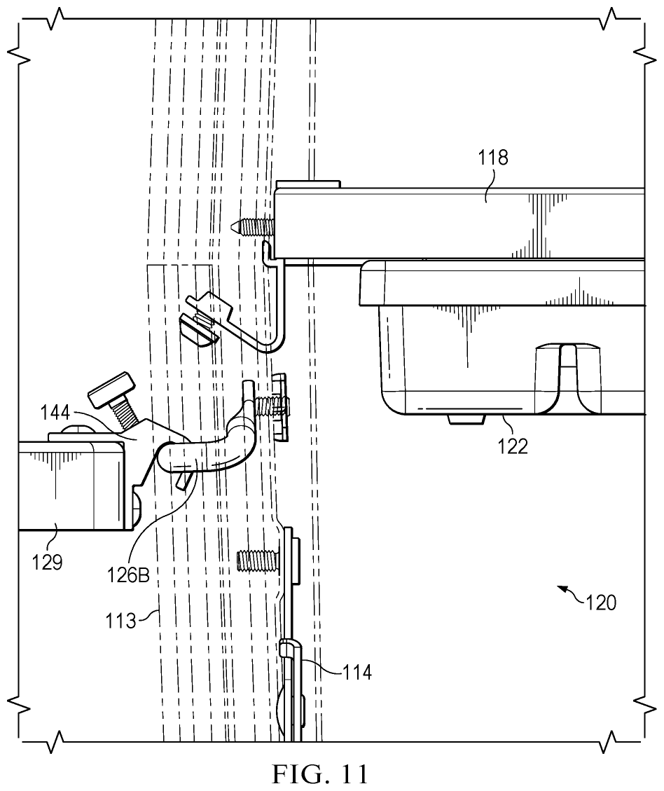

In addition to box 102, kitchen 100 includes a plurality of accessories. A user may add accessories as desired, transporting a different selection of accessories for each use of the portable kitchen. Some of the accessories may collapse and/or disassemble into components of a size allow storage in interior space 120 of box 102. The box may include any apertures, fasteners, structures, or other features appropriate for mounting of accessories. In the present example, box 102 includes mounting apertures 124 and side rungs. More specifically, each side wall 111, 113 of box 102 includes nut inserts 127 for a middle rung and a lower rung, as described further with reference to FIGS. 10 and 11, below.

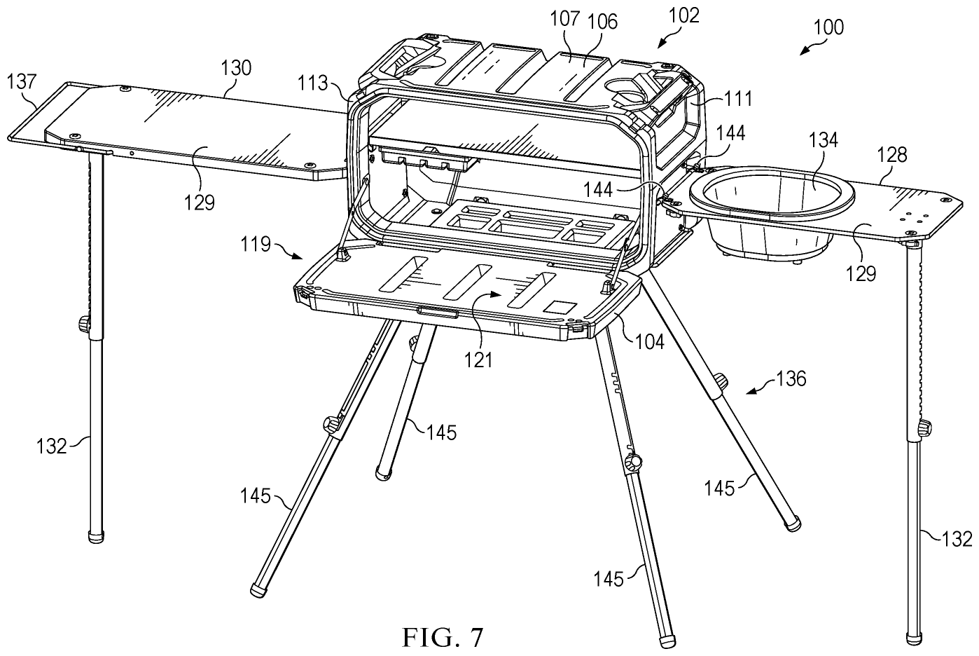

In FIG. 2, a vertical organizer 138 is installed in mounting sockets 124 on the main unit. Vertical organizer 138 is also mountable to a side counter accessory, as described regarding FIG. 7, below. In the present example, the backboard accessory is a soft goods organizer and includes a fabric body over a wireform hoop. Ends of the hoop are received by mounting sockets 124 of box 102 or similar sockets in the side counter accessory. The fabric body includes various sized pockets for universal utility, including mesh stretch pockets. Vertical organizer 138 may be used for storage and management of cooking tools, or ingredients of appropriate size such as sauces and spices, during food preparation.

Also in FIG. 2, a pole 142 for a lantern (not shown) is installed through an aperture 143 in top wall 107, proximate the back wall and second side wall 113. A corresponding aperture 143 is disposed in top wall 107 proximate first side wall 111, for an alternative position of the pole. Pole 142 extends through top wall 107 to be received in a socket in inner shelf 118, for added stability. The apertures in top wall 107 may include a flexible and/or removable seal, to prevent intrusion of water into interior space 120 when pole 142 is not installed. In some examples, pole 142 may be configured to interface with mounting sockets 124 in place of vertical organizer 138. Pole 142 may be collapsible, to allow storage in box 102.

In some examples kitchen 100 may include additional or alternative accessories, which mount to sockets 124 and/or the apertures in top wall 107. In some examples, box 102 may include additional or alternative features for mounting of accessories. A user may use other equipment in conjunction with accessories of kitchen 100. For example, the user may hang a camping lantern or any suitable light source from pole 142.

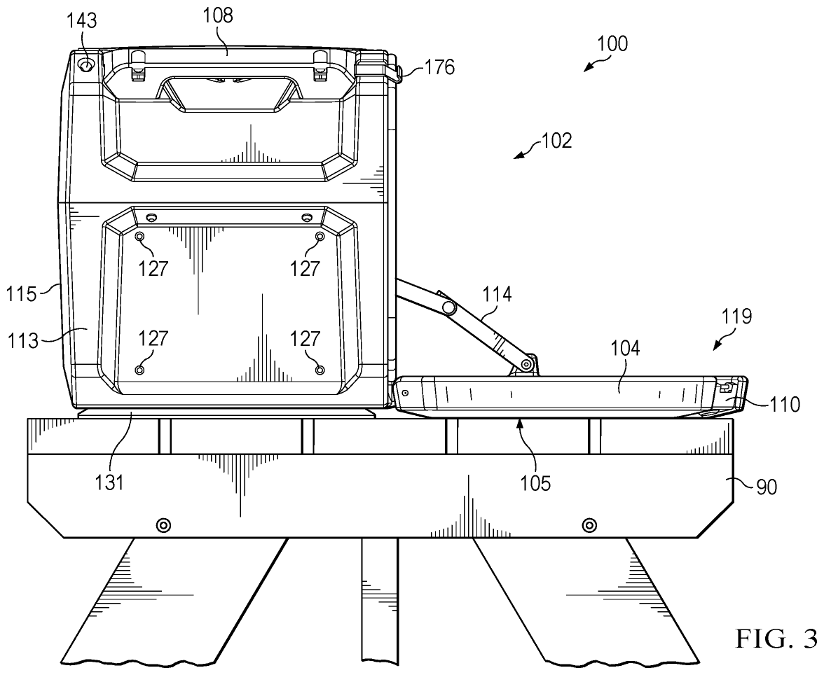

In FIG. 3, portable kitchen 100 is deployed in food preparation mode 119, on a picnic table 90. A user may use any available support at a convenient height for food preparation. Picnic tables may often be available at a campsite or other outdoor recreation location, or the user may position box 102 on the open tailgate of a truck or in the rear or a vehicle. Preferably, a support may extend under door 104, to prevent tipping when force is applied to the door in the course of use as a food preparation surface.

Enclosure 106 and an outer surface 105 of door 104 are both in contact with table 90. In the present example, cleats 131 are mounted on the bottom of enclosure 106, and the cleats support the enclosure on the table. Door 104 is hinged to enclosure 106 such that in the open position, outer surface 105 of the door is flat on the top of the table. Contact between both cleats 131 and a majority of outer surface 105, and table 90 may prevent wobbling and provide a solid food preparation surface.

Cleats 131 are further depicted in FIG. 4, which is an isometric view from below box 102. The cleats are wedge-shaped rails fastened to bottom wall 109, and are configured for connection to a vehicle hitch rack. In some examples, cleats 131 may be omitted and/or other attachment features may be included on box 102.

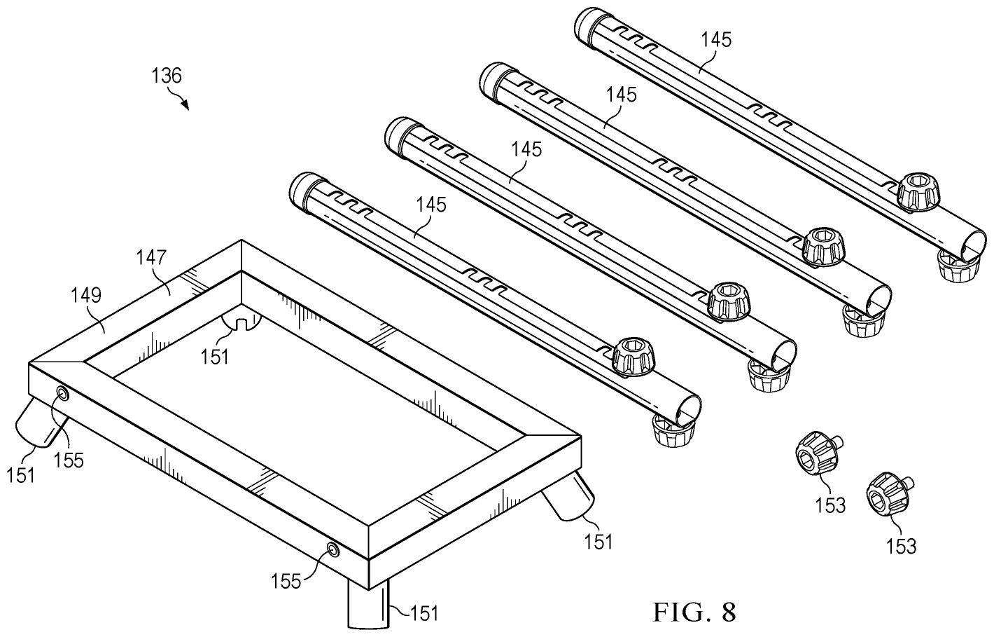

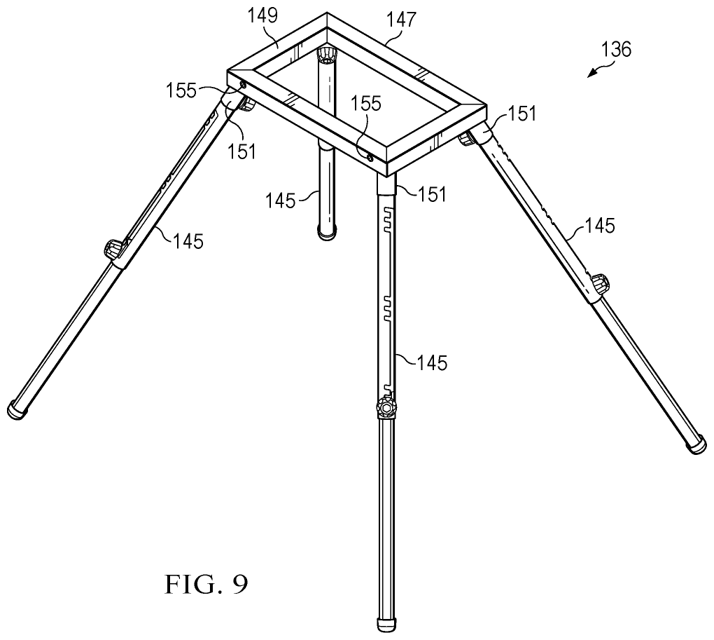

Bottom wall 109 further includes a molded rectangular channel 133, between cleats 131. The channel is configured to receive an interface portion of a leg assembly, as described further with reference to FIGS. 8 and 9, below. A pair of fastener apertures 135 extend through rear wall 115 into rectangular channel 133, to allow the leg assembly to be fastened to box 102.

FIGS. 5 and 6 are isometric and exploded views of one of latches 110. The other latch may be substantially equivalent in structure. Latch 110 includes a latch body 170 pivotably connected to latch plate 184, which is fixed to the door. The latch plate may be fastened to the door through at least two of four apertures in the plate. The two apertures may be diagonally adjacent, and selected according to which side of the door latch 110 is mounted on. In some examples, latch plate 184 may include only two apertures or may be fixed to the door by four fasteners.

Latch body 170 includes a pin 172, to be received by a hook 174 of a brace 176. The brace is fixed to the enclosure of the main unit. Latch body 170 further includes a lower pivot bar 178 fixed between two tabs 173 of latch body 170. Lower pivot bar 178 is connected by a linkage 180 to an upper pivot bar 182. The upper pivot bar is fixed between two tabs 183 of latch plate 184.

Latch body 170 may pivot about the upper and lower pivot bars, as constrained by linkage 180, to engage or disengage pin 172 from hook 174. In a latched position, pin 172 may be received by hook 174 and latch body 170 may be constrained in place, substantially parallel latch plate 184. In an unlatched position, pin 172 may be disengaged from hook 174 and latch body 170 may be free to pivot relative to latch plate 184. Latch 110 may be described as a drawn latch, or an over center latch.

Latch 110 is also locking, and further includes a lock core 186. The lock core is fixed in latch body 170 and rotates a cam plate 188 into and out of engagement with a lower tab 187 of latch plate 184. When engaged with latch plate 184, cam plate 188 may prevent pivoting of latch body 170 about upper pivot bar 182, and thereby prevent pin 172 from disengaging hook 174.

FIG. 7 depicts kitchen 100 with two side counter accessories and a leg assembly 136. Box 102 is supported on leg assembly 136, in food preparation mode 119. Leg assembly 136 includes a set of four telescoping legs 145, as shown further in FIGS. 8 and 9. The legs are adjustable to raise door 104, top wall 107, and/or accessories mounted to box 102 to a convenient height for use as a work surface while standing. A convenient height for standing food preparation may be understood to be between approximately hip height and chest height on a user and/or an ergonomically appropriate working height. Leg assembly 136 may be configured to support box 102 at a discrete plurality of heights, from which a user may select a most convenient height.

For example, inner surface 121 of door 104 and the exterior surface of top wall 107 may each be positionable at approximately a standard kitchen counter height of 91.5 centimeters (cm) or 36 inches (in). The door and/or top wall may also be positionable at heights within a range of approximately 60 cm (24 in) to 120 cm (48 in), to allow for a comfortable working height for a variety of users.

Leg assembly 136 may be used in place of a table, as depicted in FIG. 3, particularly in situations where a suitable support is not available. The legs may also be independently adjustable to different lengths, to allow leveling of kitchen 100 on uneven terrain.

As shown in FIG. 8, leg assembly 136 is configured to allow disassembly for storage and transportation. The leg assembly may also be described as stowable and/or collapsible. Leg assembly 136 includes a set of four telescoping legs 145, an upper frame 147, and a pair of fasteners 153.

Each leg 145 is independently adjustable, including an inner member with a circular aperture, and an outer member with a channel having a plurality of side recesses. The inner member is extendable relative to the outer member, and may be secured in position by a fastener extending through a recess aligned with the circular aperture. A first end of each leg includes a foot cap. A second end of each leg includes a clamping fastener and is configured to be received by upper frame 147.

Upper frame 147 includes a rectangular interfacing portion 149 configured to engage channel 133 of bottom wall 109 of box 102, as shown in FIG. 4. Interfacing portion 149 includes four rectangular elongate members, including a back member having apertures 155 configured to align with fastener apertures 135 when the interfacing portion is received in channel 133. Upper frame 147 further includes a sleeve 151 at each of the four corners of interfacing portion 149, to receive the second end of each of legs 145.

In FIG. 9, leg assembly 136 is depicted assembled. A user may assemble legs 145 with upper frame 147 and adjust the legs to level at a desired height prior to mounting box 102 on the assembly as depicted in FIG. 7. The user may then place the box onto leg assembly 136 such that the interface portion is received in the corresponding channel of the bottom wall, and install fasteners 153 (FIG. 8) to secure the box to the leg assembly. Fastening box 102 to leg assembly 136 may prevent tipping when force is applied to door 104 in the course of use as a food preparation surface.

Referring again to FIG. 7, a first side counter accessory 128 is shown mounted to first side wall 111 and a second side counter accessory 130 is mounted to second side wall 113. Side counter 128 may also be referred to as a sink counter or sink support, and side counter 130 may also be referred to as a side table, work counter, or kitchen counter accessory.

Each side counter 128, 130 includes a planar expanse 129, a telescoping leg 132, and a pair of connectors 144. Planar expanse 129 of first side counter 128 includes an opening in which a collapsible sink 134 is mounted. In some examples sink 134 may be removable and/or replaceable with other inserts such as a cutting board. Second side counter 130 further includes a utility bar 137, which may be used for a towel and/or to suspend other equipment. In some examples, one or both of the side counters may include additional features such as a removable bracket for a propane tank, water source, and/or a hose sprayer attachment for use with sink 134.

Each side counter 128, 138 is alternatively attachable to box 102 on either of side walls 111, 113. Each side counter is supported in a horizontal orientation by connection to box 102 at one end and telescoping leg 132 at an opposite end. Legs 132 may be configured similarly to legs 145 of assembly 136 (FIG. 8). The legs may also be removable, for storage and transportation.

Each side counter is selectively attachable to rungs on box 102 by connectors 144. As shown in FIGS. 1 and 4, side wall 111 and 113 of box 102 each include nut inserts 127 for fastening of two rail structures or rungs to the exterior side. In FIG. 10, a middle rung 1266 and a lower rung 126C are shown fastened to second side wall 113. In the present example, the middle and lower rungs comprise a stamped steel round bar. A top rung 126A is formed in the respective one of lift handles 108, and as two divided sections. First side wall 111 may be similarly configured, and a user may install middle rungs 126B and lower rungs 126C on either or both of the side walls as desired.

The top, middle, and bottom rungs may provide three mounting heights for side accessories. Referring again to FIG. 7, the first and second side counters 128, 130 are each depicted mounted on the middle rung. Each leg 132 has been adjusted to match the height of the middle rung of box 102, and thereby level the respective side counter.

In some examples, box 102 may include recesses, apertures, or other features for connection of side counter accessories. The side counter accessories may be selectively attachable at multiple working heights.

Connectors 144 of the side counters are configured to attach to any of the three rails at the side of the main unit. Second side wall 113 and one connector 144 of second side counter 130 are shown in cross-section in FIG. 11, with the side wall depicted as transparent.

In the present example, connector 144 is a bracket fastened to an edge of planar expanse 129, with a hook over rung 126. A clamp screw extends through an aperture in the bracket to engage the rung, and secure connector 144 to the rung. In some examples, connector 144 may include a gate-latch style mechanism with a pivotable latch structure. In some examples, connector 144 may be a plastic injection molded hook with a barb shaped snap feature. Connector 144 may also be configured to engage other features of the side wall, and/or may include any effective engaging structure(s).

### Illustrative Combinations and Additional Examples

This section describes additional aspects and features of portable food preparation apparatus, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.

A0. A portable food preparation apparatus, comprising:
a main body including:
   a top wall and a bottom wall,
   three side walls connecting the top and bottom walls,
   a door hinged to an edge of the bottom wall and securable to the top wall, and
   an interior compartment defined by the top, bottom, and side walls,
wherein the door has a transport position perpendicular to the top and bottom walls, and a food preparation position in which the door is parallel the top and bottom walls, and
wherein the interior compartment is configured for storage of food preparation equipment when the door is in the transport position, and an inner side of the door is configured for use as a work surface when the door is in the food preparation position.

A1. The apparatus of A0, wherein the door is latched to the top wall in the transport position, and unlatched from the top wall in the food preparation position.

A2. The apparatus of A0 or A1, further including a plurality of accessories, attachable to the main body.

A3. The apparatus of A2, wherein the accessories include one or more of (a) a sink, (b) a grill, (c) a light, (d) an organizer, (e) a shelf, (f) a drawer, (g) a table.

A4. The apparatus of A2 or A3, wherein the interior compartment is configured for storage of the plurality of accessories.

A5. The apparatus of any of A0-A4, wherein a side wall of the three side walls includes a rail structure on an exterior side, and the portable food preparation apparatus includes an accessory mountable to the rail structure.

A6. The apparatus of A5, wherein the accessory includes a work surface having a leg and a pair of connectors configured for removable attachment to the rail structure.

A7. The apparatus of A6, wherein the leg is adjustable in length and the side wall includes multiple rail structures on the exterior side, the work surface being thereby securable at multiple working heights.

A8. The apparatus of A6 or A7, wherein each of the pair of connectors comprises a deformable material and is attachable to the rail structure by a snap-fit mechanism.

A9. The apparatus of any of A6-A8, wherein each of the pair of connectors includes a pivotable latch portion and a channel configured to receive the rail structure, the rail structure urging the latch portion to pivot when being received into the channel, and the latch portion blocking removal of the rail structure once received into the channel.

A10. The apparatus of A9, wherein the latch portion is manually pivotable to release the rail structure from the channel.

A11. The apparatus of any of A0-A10, wherein the top wall includes a pair of handles for lifting the portable food preparation apparatus.

A12. The apparatus of any of A0-A11, further including a set of legs which are removably attachable to the bottom wall, for support of the main body.

A13. The apparatus of any of A0-A12, further including a mounting structure fixed to the bottom wall, for connection to a vehicle-mounted load carrier.

A14. The apparatus of A13, wherein the mounting structure includes a pair of wedge-shaped cleats.

A15. The apparatus of any of A0-A14, wherein the door is securable to the top wall by a pair of over center latches, each further including a cam lock.

B0. A method of outdoor food preparation, comprising:
packing food preparation equipment into a portable food preparation apparatus,
closing a door of the apparatus,
transporting the apparatus to an outdoor location, with a vehicle,
opening the door of the apparatus,
mounting at least one accessory to the apparatus,
preparing food using the packed equipment and using the opened door as a work surface.

B1. The method of B0, further including mounting the apparatus to a load carrier mounted on the vehicle.

B2. The method of B0 or B1, wherein mounting the at least one accessory to the apparatus includes receiving a rail portion of the apparatus in each of a pair of connectors of the at least one accessory.

B3. The method of any of B0-B2, wherein mounting the at least one accessory to the apparatus includes inserting a supporting pole of the accessory into a corresponding aperture of the apparatus.

C0. A portable kitchen assembly, comprising:
a rectangular container having a top wall, bottom wall, back wall, front wall, first and second side walls, the front wall being configured to open to a kitchen counter position, and
stowable legs attachable to an external side of the bottom wall
for supporting the container at a convenient height for standing preparation of food.

C1. The portable kitchen assembly of C0, wherein the legs are adjustable to a plurality of heights.

C2. The portable kitchen assembly of C0 or C1, further including a first side counter member alternatively attachable to an external side of the first side wall and an external side of the second side wall.

C3. The portable kitchen assembly of C2, wherein the external side of each the first side wall and the second side wall has plural rail structures for fastening the first side counter at multiple different heights.

C4. The portable kitchen assembly of C2 or C3, wherein the first side counter has a telescoping leg for supporting the first side counter in a horizontal orientation.

C5. The portable kitchen assembly of any of C2-C4, wherein the first side counter has an opening configured to support a sink.

C6. The portable kitchen assembly of any of C0-05, further including a second side counter member alternatively attachable to the external side of the first side wall and the external side of the second side wall.

C7. The portable kitchen assembly of any of C0-C6, further including a kitchen implement organizer configured for attachment to an external side of the top wall.

C8. The portable kitchen assembly of any of C0-C7, further including an interior shelf and a utensil tray suspended from the interior shelf.

C9. The portable kitchen assembly of any of C0-C8, further including a gas source configured for attachment to the container or a side counter and connection to a stove.

C10. The portable kitchen assembly of any of C0-C9, further including a lamp attachable to the top wall or a side wall of the container.

C11. The portable kitchen assembly of any of C0-C10, further including a clamp device for connecting the container to a vehicle hitch rack.

D0. A portable kitchen, comprising
a rectangular box including an enclosure and a front door, the front door opening through 90 degrees to a flat position,
a horizontal shelf mounted in the enclosure,
a utensil tray suspended from the horizontal shelf, and
an organizer having a plurality of pockets and being selectively mountable in a vertical orientation on top of the enclosure.

D1. The portable kitchen of D0, wherein the enclosure and the door comprise rotomolded plastic.

D2. The portable kitchen of D0 or D1, wherein the door and each wall of the enclosure includes a plurality of recesses.

### CONCLUSION

It is believed that the disclosure set forth herein encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the disclosure includes all novel and non-obvious combinations and sub-combinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

The various structural members disclosed herein may be constructed from any suitable material, or combination of materials, such as metal, plastic, nylon, rubber, or any other materials with sufficient structural strength to withstand the loads incurred during use. Materials may be selected based on their durability, flexibility, weight, and/or aesthetic qualities.

Although the present disclosure has been provided with reference to the foregoing operational principles and embodiments, it will be apparent to those skilled in the art that various changes in form and detail may be made without departing from the spirit and scope of the disclosure. The present disclosure is intended to embrace all such alternatives, modifications and variances. Where the disclosure recites “a,” “a first,” or “another” element, or the equivalent thereof, it should be interpreted to include one or more such elements, neither requiring nor excluding two or more such elements. Furthermore, any aspect shown or described with reference to a particular embodiment should be interpreted to be compatible with any other embodiment, alternative, modification, or variance.

It is believed that the following claims particularly point out certain combinations and sub-combinations that are directed to one of the disclosed inventions and are novel and non-obvious. Inventions embodied in other combinations and sub-combinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

We claim:

1. A portable kitchen assembly, comprising:
a substantially rectangular container having a top wall, bottom wall, back wall, front wall, first and second side walls, the front wall being configured to open to a kitchen counter position, and
stowable legs attachable to an external side of the bottom wall
for supporting the container at a convenient height for standing preparation of food.

2. The portable kitchen assembly of claim 1, wherein the legs are adjustable to a plurality of heights.

3. The portable kitchen assembly of claim 1, further including a first side counter member alternatively attachable to an external side of the first side wall and an external side of the second side wall.

4. The portable kitchen assembly of claim 3, wherein the external side of each of the first side wall and the second side wall has plural rail structures for selectably fastening the first side counter at multiple different heights.

5. The portable kitchen assembly of claim 3, wherein the first side counter has a telescoping leg for supporting the side counter in a horizontal orientation.

6. The portable kitchen assembly of claim 3, wherein the first side counter has an opening configured to support a sink.

7. The portable kitchen assembly of claim 1, further including a second side counter member alternatively attachable to the external side of the first side wall and the external side of the second side wall.

8. The portable kitchen assembly of claim 1, further including a kitchen implement organizer configured for attachment to an external side of the top wall.

9. The portable kitchen assembly of claim 1, further including an interior shelf and a utensil tray suspended from the interior shelf.

10. A portable food preparation apparatus, comprising:
a main body including:
a top wall and a bottom wall,
three side walls connecting the top and bottom walls,
a door hinged to an edge of the bottom wall and securable to the top wall, and
an interior compartment defined by the top, bottom, and side walls,
wherein the door has a transport position perpendicular to the top and bottom walls, and a food preparation position in which the door is parallel the top and bottom walls, and
wherein the interior compartment is configured for storage of food preparation equipment when the door is in the transport position, and an inner side of the door is configured for use as a work surface when the door is in the food preparation position.

11. The apparatus of claim 10, wherein the door is latched to the top wall in the transport position, and unlatched from the top wall in the food preparation position.

12. The apparatus of claim 10, wherein a side wall of the three side walls includes a rail structure on an exterior side, and the portable food preparation apparatus includes an accessory mountable to the rail structure.

13. The apparatus of claim 12, wherein the accessory includes a work surface having a leg and a pair of connectors configured for removable attachment to the rail structure.

14. The apparatus of claim 13, wherein the leg is adjustable in length and the side wall includes multiple rail structures on the exterior side, the work surface being thereby securable at multiple working heights.

15. The apparatus of claim 10, wherein the top wall includes a pair of handles for lifting the portable food preparation apparatus.

16. The apparatus of claim 10, further including a set of legs which are removably attachable to the bottom wall, for support of the main body.

17. The apparatus of claim 10, wherein the door is securable to the top wall by a pair of over center latches, each further including a cam lock.

18. A portable kitchen, comprising
a rectangular box including an enclosure and a front door, the front door opening from a vertical position through 90 degrees to a horizontal position,
a horizontal shelf mounted in the enclosure,
a utensil tray suspended from the horizontal shelf, and
an organizer having a plurality of pockets and being selectively mountable in a vertical orientation on top of the enclosure.

19. The portable kitchen of claim 18, wherein the enclosure and the door comprise rotomolded plastic.

20. The portable kitchen of claim 19, wherein the door and each wall of the enclosure includes a plurality of recesses.
